(19) United States
(12) Patent Application Publication
(10) Pub. No.: US 2026/0295517 A1
(43) Pub. Date: Oct. 1, 2026

(54) SOLID DESICCANT SYSTEM FOR DEHUMIDIFICATION

(71) Applicant: Carrier Corporation, Palm Beach Gardens, FL (US)

(72) Inventors: Weina Li, Acton, MA (US); Bart Antonie van Hassel, Weatogue, CT (US); Stella Maris Oggianu, West Hartford, CT (US); Aaron Kueck, Ithaca, NY (US); Matthew Patterson, East Syracuse, NY (US)

(21) Appl. No.: 19/630,735

(22) Filed: Mar. 27, 2026

Related U.S. Application Data
(60) Provisional application No. 63/779,546, filed on Mar. 28, 2025.

(51) Int. Cl. B01D 53/26; B01D 53/04; B01D 53/28; B01J 20/10; B01J 20/22; F28F 13/18

(52) U.S. Cl. CPC B01D 53/261; B01D 53/0438; B01D 53/28; B01J 20/103; B01J 20/226; F28F 13/187; B01D 2253/106; B01D 2253/204; B01D 2257/80; B01D 2258/06; F28F 2245/02

(57) ABSTRACT

An independent dehumidification element is provided. The independent dehumidification element includes pluralities of elements disposable in an airstream. The surface of at least one element of the plurality of elements includes an adsorbent coating. The adsorbent coating includes at least two or more solid adsorbents that differ from one another in one of a homogenous mixture and a heterogenous combination.

### CROSS-REFERENCE TO RELATED APPLICATIONS

This application claims the benefit of U.S. provisional patent application Ser. No. 63/779,546, filed Mar. 28, 2025, the entire contents of which are incorporated herein by reference.

### BACKGROUND

The present disclosure relates to heating, ventilation and air-conditioning (HVAC) systems and, more particularly, to an advanced HVAC system that includes independent dehumidification based on solid desiccants.

A desiccant is a substance that adsorbs moisture from the environment, due to its high affinity for water vapor, thus helping to keep the surrounding area dry. Desiccants typically include hygroscopic materials that attract and hold water vapor from the air to induce or sustain a state of dryness (desiccation) in its vicinity. Industrially, desiccants are widely used for moisture control in packaging, pharmaceuticals, electronics, food preservation and dehumidification systems to maintain product integrity and prevent corrosion.

### BRIEF DESCRIPTION

According to an aspect of the disclosure, an independent dehumidification element is provided. The independent dehumidification element includes pluralities of elements disposable in an airstream. The surface of at least one element of the plurality of elements includes an adsorbent coating. The adsorbent coating includes at least two or more solid adsorbents that differ from one another in one of a homogenous mixture and a heterogenous combination.

In accordance with at least one or more additional and/or alternative embodiments, the at least two or more solid adsorbents are each selected from a group including desiccants in metal-organic frameworks (MOFs), desiccants in MOFs with integrated graphite, silica-based desiccants, molecular sieves, zeolites and polymer-based desiccants.

In accordance with at least one or more additional and/or alternative embodiments, the at least two or more solid adsorbents each includes a desiccant in a metal-organic framework (MOF) and a silica-based desiccant.

In accordance with at least one or more additional and/or alternative embodiments, the at least two or more solid adsorbents each includes first and second desiccants in metal-organic frameworks (MOFs) with different metallic center chemistries.

In accordance with at least one or more additional and/or alternative embodiments, the at least two or more solid adsorbents each includes first and second desiccants in metal-organic frameworks (MOFs) with different organic linking chemistries.

In accordance with at least one or more additional and/or alternative embodiments, the at least two or more solid adsorbents respectively include a first desiccant in a metal-organic framework (MOF) with first multiple metallic center chemistries and a second desiccant in an MOF with second multiple metallic center chemistries differing from the first multiple metallic center chemistries.

According to an aspect of the disclosure, a heat exchanger is provided. The heat exchanger includes a plurality of tubes and a plurality of fins. Each fin of the plurality of fins is in thermal contact with at least one tube of the plurality of tubes. Each fin of the plurality of fins and each tube of the plurality of tubes has a surface including an adsorbent coating. The adsorbent coating includes at least two or more solid adsorbents that differ from one another.

In accordance with at least one or more additional and/or alternative embodiments, the at least two or more solid adsorbents are each selected from a group including desiccants in metal-organic frameworks (MOFs), desiccants in MOFs with integrated graphite, silica-based desiccants, molecular sieves, zeolites and polymer-based desiccants.

In accordance with at least one or more additional and/or alternative embodiments, the at least two or more solid adsorbents each includes a desiccant in a metal-organic framework (MOF) and a silica-based desiccant.

In accordance with at least one or more additional and/or alternative embodiments, the at least two or more solid adsorbents each includes first and second desiccants in metal-organic frameworks (MOFs) with different metallic center chemistries.

In accordance with at least one or more additional and/or alternative embodiments, the at least two or more solid adsorbents each includes first and second desiccants in metal-organic frameworks (MOFs) with different organic linking chemistries.

In accordance with at least one or more additional and/or alternative embodiments, the at least two or more solid adsorbents respectively include a first desiccant in a metal-organic framework (MOF) with first multiple metallic center chemistries and a second desiccant in an MOF with second multiple metallic center chemistries differing from the first multiple metallic center chemistries.

In accordance with at least one or more additional and/or alternative embodiments, the respective pluralities of tubes and fins are arranged in layers and the adsorbent coating including the at least two or more solid adsorbents of one of the layers differs from the adsorbent coating including the at least two or more solid adsorbents of another one of the layers.

In accordance with at least one or more additional and/or alternative embodiments, the respective pluralities of tubes and fins are arranged in sections and the adsorbent coating including the at least two or more solid adsorbents of one of the sections differs from the adsorbent coating including the at least two or more solid adsorbents of another one of the sections.

According to an aspect of the disclosure, a dehumidification system is provided. The dehumidification system includes first and second heat exchangers in one of a series arrangement and a parallel arrangement. Each of the first and second heat exchangers includes a plurality of tubes and a plurality of fins. Each fin of the plurality of fins is in thermal contact with at least one tube of the plurality of tubes. Each fin of the plurality of fins and each tube of the plurality of tubes has a surface including an adsorbent coating. Each adsorbent coating of each of the first and second heat exchangers includes first and second solid adsorbents, which differ from one another.

In accordance with at least one or more additional and/or alternative embodiments, the first solid adsorbent of each adsorbent coating of each of the first and second heat exchangers is selected from a group including desiccants in metal-organic frameworks (MOFs), desiccants in MOFs with integrated graphite, silica-based desiccants, molecular sieves, zeolites and polymer-based desiccants and the second solid adsorbent of each adsorbent coating of each of the first and second heat exchangers is selected from a group including desiccants in metal-organic frameworks (MOFs), desiccants in MOFs with integrated graphite, silica-based desiccants, molecular sieves, zeolites and polymer-based desiccants.

In accordance with at least one or more additional and/or alternative embodiments, the first solid adsorbent includes a desiccant in a metal-organic framework (MOF) and the second solid adsorbent comprises a silica-based desiccant.

In accordance with at least one or more additional and/or alternative embodiments, the first and second solid adsorbents of each adsorbent coating of each of the first and second heat exchangers respectively include first and second desiccants in metal-organic frameworks (MOFs) with different metallic center chemistries.

In accordance with at least one or more additional and/or alternative embodiments, the first and second solid adsorbents of each adsorbent coating of each of the first and second heat exchangers respectively include first and second desiccants in metal-organic frameworks (MOFs) with different organic linking chemistries.

In accordance with at least one or more additional and/or alternative embodiments, the first solid adsorbent of each adsorbent coating of each of the first and second heat exchangers includes a first desiccant in a metal-organic framework (MOF) with first multiple metallic center chemistries and the second solid adsorbent of each adsorbent coating of each of the first and second heat exchangers includes a second desiccant in an MOF with second multiple metallic center chemistries differing from the first multiple metallic center chemistries.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 are perspective views of increasing magnification of a heat exchanger with at least two or more solid adsorbents in accordance with embodiments;

FIG. 2 are diagrams illustrating a process of assembling a metal-organic framework (MOF) with a metal center and organic linkages for use in the at least two or more solid adsorbents of FIG. 1 in accordance with embodiments;

FIG. 3 is a side view of a heat exchanger or another suitable device, such as a desiccant wheel, with multiple layers having coatings with different solid adsorbents in accordance with embodiments;

FIG. 4 is a side view of a heat exchanger or another suitable device, such as a desiccant wheel, with multiple sections having coatings with different solid adsorbents in accordance with embodiments;

FIG. 5 is a side view of a dehumidification system with serial heat exchangers or other suitable devices, such as desiccant wheels, having coatings with different solid adsorbents in accordance with embodiments; and

FIG. 6 is a side view of a dehumidification system with parallel heat exchangers or other suitable devices, such as desiccant wheels, having coatings with different solid adsorbents in accordance with embodiments.

### DETAILED DESCRIPTION

In air-conditioning applications, latent cooling loads can account for 30% of total air-conditioning loads. This can be even higher in tropical and subtropical climates. As the same time, traditional vapor-compression air-conditioning can have a low coefficient of performance (COP) due to the need to cool the air to its dew point to extract its humidity. This consequently requires re-heating to bring air temperatures up following dehumidification before the air is supplied to an indoor environment and results in relatively low energy efficiency.

A need therefore exists for development of new technologies for energy efficient HVAC systems that provide dehumidification.

Thus, as will be described below, an advanced solid desiccant system is provided to facilitate dehumidification in HVAC systems, The solid desiccant system promises energy savings via a separation of latent heat from sensitive heat. The solid desiccant system includes a mixture of two or more solid adsorbents; or a single solid adsorbent which is engineered to have a structural mix or two or more metals as part of its composition. These adsorbents could be a combination of different metal organic frameworks (MOFs), a MOF with two or more different metals in its structure, or different types of adsorbents. The adsorbents could be selected from adsorbent groups such as MOFs, silica-based materials, molecular sieves, zeolites, polymer-based materials, composites, etc. to form a mixed adsorbent system. The purpose of employing a mixed adsorbent system is to enable the combined features from each individual adsorbent and be able to further improve overall performance while offering cost reductions.

For example, silica gel adsorbs water at a relative humidity (RH) of 60% to 80% while MIL- 100 (Fe) works between RH of 30% to 90%. When silica gel and MIL-100 (Fe) are mixed, the adsorption capability could be expanded to a broader RH window than what is provided by each on an individual basis with cost reductions due to a lower cost of silica gel than MIL-100(Fe). As another example, MOF itself might have low a thermal conductivity which limits the rate at which adsorption heat can be removed causing sorbent temperatures to rise and capacity to drop. If a high thermal conductivity material like graphite is integrated with MOFs, it will help heat transfer. Therefore, this advanced desiccant system will enable the improvement of system efficiency, broader operation windows and potential cost reductions.

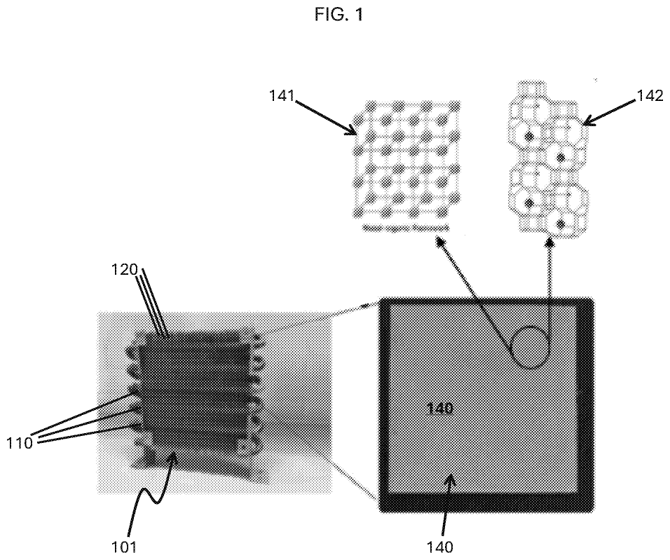

With reference to FIG. 1, an independent dehumidification element, such as heat exchanger 101 is provided and includes pluralities of elements that are disposable in an airstream. In the exemplary case of the independent dehumidification element being the heat exchanger 101, the heat exchanger 101 includes a plurality of tubes 110 and a plurality of fins 120. Each fin 120 of the plurality of fins 120 is disposed in thermal contact with at least one tube 110 of the plurality of tubes 110. Each fin 120 of the plurality of fins 120 and each tube 110 of the plurality of tubes 110 has a surface 130. The surface 130 of at least one of one fin 120 of the plurality of fins 120 and one tube 110 of the plurality of tubes 110 includes an adsorbent coating 140. The adsorbent coating 140 includes at least two or more solid adsorbents 141 and 142 that differ from one another in one of a homogenous mixture and a heterogenous combination. Due to the use of the at least two or more solid adsorbents 141 and 142 that differ from one another, the heat exchanger 101 has a mixed adsorbent quality in which the features and capabilities of each of the at least two or more solid adsorbents 141 and 142 are combined to improve overall performance of the heat exchanger 101, relative to its moisture adsorption capabilities.

The following description will generally relate to the cases in which the independent dehumidification element is the heat exchanger 101. This is being done for purposes of clarity and brevity and should not be interpreted as limiting the description or the following claims in any way. For example, it is to be understood that the independent dehumidification element could be the heat exchanger 101, a desiccant wheel or another other suitable feature.

While the adsorbent coating 140 can be provided on only one surface of the one fin 120 of the plurality of fins 120 and the one tube 110 of the plurality of tubes 110, the following description will relate to the case in which each fin 120 of the plurality of fins 120 and each tube 110 of the plurality of tubes 110 has the surface 130 including the adsorbent coating 140 including the at least two or more solid adsorbents 141 and 142. This is being done for purposes of clarity and brevity and should not be interpreted as limiting the following description or the claims in any way.

The at least two or more solid adsorbents 141 and 142 can each be selected from a group comprising desiccants in MOFs, desiccants in MOFs with integrated graphite to improve heat transfer, silica-based desiccants, molecular sieves, zeolites and polymer-based desiccants, the at least two or more solid adsorbents 141 and 142 can each include an MOF desiccant and a silica-based desiccant, the at least two or more solid adsorbents 141 and 142 can each include first and second desiccants in MOFs with different metallic center chemistries, the at least two or more solid adsorbents 141 and 142 can each include first and second desiccants in MOFs with different organic linking chemistries and the at least two or more solid adsorbents 141 and 142 can respectively include a first desiccant in an MOF with first multiple metallic center chemistries and a second desiccant in an MOF with second multiple metallic center chemistries differing from the first multiple metallic center chemistries.

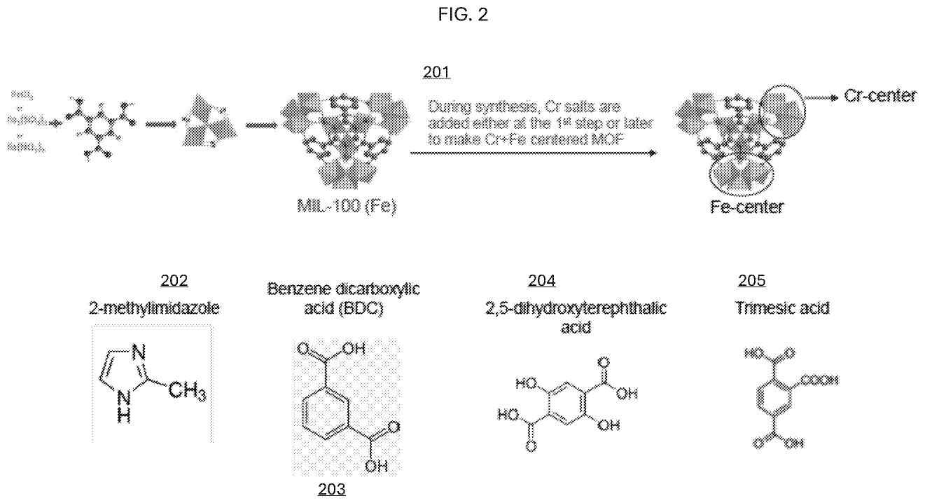

In accordance with embodiments and with reference to FIG. 2, which illustrated an exemplary process 201 for forming an MOF, an MOF can include one or more metals in one MOF structure formed of one or more organic linkers. The one or more metals can include, but are not limited to, iron, chromium, zinc, hafnium, zirconium, magnesium and aluminum. In some cases, one metal atom is provided in one MOF structure and in some other cases, multiple metal atoms (i.e., multiple metallic center chemistry) are provided in one MOF structure. The organic linkers can include, but are not limited to, 2-methylimidazole 202, benzene dicarboxylic acid (BDC) 203, 2,5-dihydroxyterephthalic acid 204 and trimesic acid 205.

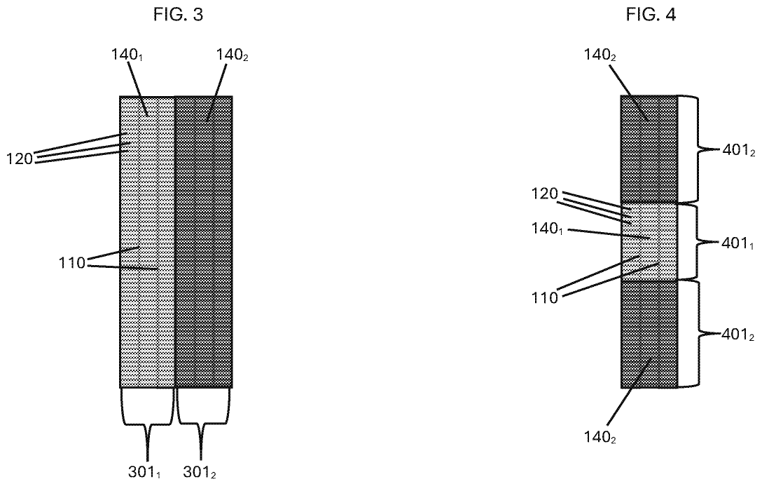

The following description applies to the various embodiments of FIGS. 3-6. To whatever extent these embodiments relate to cases where different desiccants are combined or mixed into homogenous mixtures, it is to be understood that they apply equally to cases in which the different desiccants can coat heat exchangers in heterogenous combinations as well.

With reference back to FIG. 1 and with additional reference to FIG. 3, the respective pluralities of tubes 110 and fins 120 can be arranged in layers 301₁, 301₂ with the adsorbent coating 140₁ of layer 301₁ (i.e., some combination of the solid adsorbent 141 and the solid adsorbent 142) optionally differing from the adsorbent coating 140₂ of layer 301₂ (i.e., some combination of the solid adsorbent 141 and the solid adsorbent 142).

In these or other cases, the heat exchanger 101 can be placed in an airflow for a dehumidification system (see below) whereby the adsorbent coating 140₁ of layer 301₁ and the adsorbent coating 140₂ of layer 301₂ serve to remove humidity from the airflow. Due to the differences between the adsorbent coating 140₁ of layer 301₁ and the adsorbent coating 140₂ of layer 301₂, the heat exchanger 101 may exhibit optimized performance where the humidity of the airflow changes over time. That is, the adsorbent coating 140₁ of layer 301₁ may be optimized for the airflow under certain types of conditions and the adsorbent coating 140₂ of layer 301₂ may be optimized for the airflow under other certain types of conditions. For example, the adsorbent coating 140₁ of layer 301₁ may be optimized for the airflow during daylight hours when relative humidity is relatively low and the adsorbent coating 140₂ of layer 301₂ may be optimized for the airflow during nighttime hours when relative humidity is relatively high.

With reference back to FIG. 1 and with additional reference to FIG. 4, the respective pluralities of tubes 110 and fins 120 can be arranged in sections 401₁, 401₂ with the adsorbent coating 140₁ of section 401₁ (i.e., some combination of the solid adsorbent 141 and the solid adsorbent 142) optionally differing from the adsorbent coating 140₂ of section 401₂ (i.e., some combination of the solid adsorbent 141 and the solid adsorbent 142).

In these or other cases, the heat exchanger 101 can be placed in an airflow for a dehumidification system (see below) whereby the adsorbent coating 140₁ of section 401₁ and the adsorbent coating 140₂ of section 401₂ serve to remove humidity from the airflow. Due to the differences between the adsorbent coating 140₁ of section 401₁ and the adsorbent coating 140₂ of section 401₂, the heat exchanger 101 may exhibit optimized performance where the humidity of the airflow differs along the plane of the heat exchanger 101. That is, the adsorbent coating 140₁ of section 401₁ may be optimized for the type of airflow associated with section 401₁ and the adsorbent coating 140₂ of section 401₂ may be optimized for the type of airflow associated with section 401₂. For example, the adsorbent coating 140₁ of (peripheral) section 401₁ may be optimized for peripheral portions of the airflow that can have relatively high levels of relative humidity and the adsorbent coating 140₂ of (central) section 401₂ may be optimized for central regions of the airflow that can have relatively low levels of relative humidity.

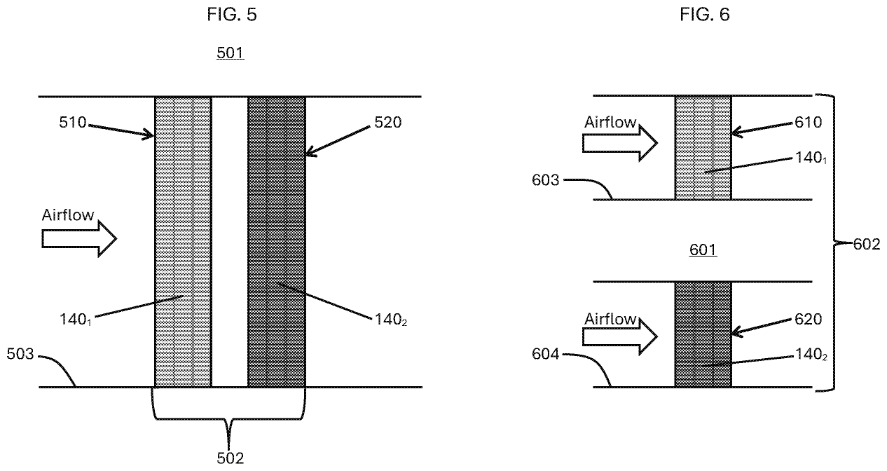

With reference back to FIG. 1 and with additional reference to FIG. 5, a dehumidification system 501 is provided and includes a first heat exchanger 510 and a second heat exchanger 520 in a series arrangement 502. Each of the first heat exchanger 510 and the second heat exchanger 520 is structured similarly as described above with respect to the heat exchanger 101 of FIG. 1, with the adsorbent coating 140₁ of the first heat exchanger 510 including a first solid adsorbent (i.e., some combination of the solid adsorbent 141 and the solid adsorbent 142) and with the adsorbent coating 140₂ of the second heat exchanger 520 including a second solid adsorbent (i.e., some combination of the solid adsorbent 141 and the solid adsorbent 142), which optionally differ from one another.

In these or other cases, the dehumidification system 501 can further include various airflow pumps, valves, baffles, etc., as well as a duct 503 in which the first and second heat exchangers 510 and 520 are disposed to dehumidify an airflow whereby the adsorbent coating 140₁ of the first heat exchanger 510 and the adsorbent coating 140₂ of the second heat exchanger 520 serve to remove humidity from the airflow. Due to the differences between the adsorbent coating 140₁ of the first heat exchanger 510 and the adsorbent coating 140₂ of the second heat exchanger 520, the dehumidification system 501 may exhibit optimized performance where the humidity of the airflow changes over time. That is, the adsorbent coating 140₁ of the first heat exchanger 510 may be optimized for the airflow under certain types of conditions and the adsorbent coating 140₂ of the second heat exchanger 520 may be optimized for the airflow under other certain types of conditions. For example, the adsorbent coating 140₁ of the first heat exchanger 510 may be optimized for the airflow during daylight hours when relative humidity is relatively low and the adsorbent coating 140₂ of the second heat exchanger 520 may be optimized for the airflow during nighttime hours when relative humidity is relatively high.

With reference back to FIG. 1 and with additional reference to FIG. 6, a dehumidification system 601 is provided and includes a first heat exchanger 610 and a second heat exchanger 620 in a parallel arrangement 602. Each of the first heat exchanger 610 and the second heat exchanger 620 is structured similarly as described above with respect to the heat exchanger 101 of FIG. 1, with the adsorbent coating 140₁ of the first heat exchanger 610 including a first solid adsorbent (i.e., some combination of the solid adsorbent 141 and the solid adsorbent 142) and with the adsorbent coating 140₂ of the second heat exchanger 620 including a second solid adsorbent (i.e., some combination of the solid adsorbent 141 and the solid adsorbent 142), which optionally differ from one another.

In these or other cases, the dehumidification system 601 can include various airflow pumps, valves, baffles, etc., as well as ducts 603 and 604 in which the first and second heat exchangers 610 and 620 are respectively disposed whereby the adsorbent coating 140₁ of the first heat exchanger 610 and the adsorbent coating 140₂ of the second heat exchanger 620 serve to remove humidity from the airflow. Due to the differences between the adsorbent coating 140₁ of the first heat exchanger 610 and the adsorbent coating 140₂ of the second heat exchanger 620, the dehumidification system 601 may exhibit optimized performance where the humidity of the airflow differs among the ducts 603 and 604. That is, the adsorbent coating 140₁ of the first heat exchanger 610 may be optimized for the type of airflow associated with duct 603 and the adsorbent coating 140₂ of the second heat exchanger 620 may be optimized for the type of airflow associated with duct 604. For example, the adsorbent coating 140₁ of the first heat exchanger 610 may be optimized for relatively high levels of relative humidity in duct 603 and the adsorbent coating 140₂ of the second heat exchanger 620 may be optimized for relatively low levels of relative humidity in duct 604.

Technical effects and benefits of the present disclosure are the provision of a solid desiccant system that offers improved energy efficiency, improved water adsorption capacity, broader operational windows, cost reductions and potentially expanded applications on carbon capture, volatile organic compounds (VOCs) and dehumidification.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. An independent dehumidification element, comprising:
pluralities of elements disposable in an airstream,
the surface of at least one element of the plurality of elements comprising an adsorbent coating, and
the adsorbent coating comprising at least two or more solid adsorbents that differ from one another in one of a homogenous mixture and a heterogenous combination.

2. The independent dehumidification element according to claim 1, wherein the at least two or more solid adsorbents are each selected from a group comprising desiccants in metal-organic frameworks (MOFs), desiccants in MOFs with integrated graphite, silica-based desiccants, molecular sieves, zeolites and polymer-based desiccants.

3. The independent dehumidification element according to claim 1, wherein the at least two or more solid adsorbents each comprises a desiccant in a metal-organic framework (MOF) and a silica-based desiccant.

4. The independent dehumidification element according to claim 1, wherein the at least two or more solid adsorbents each comprises first and second desiccants in metal-organic frameworks (MOFs) with different metallic center chemistries.

5. The independent dehumidification element according to claim 1, wherein the at least two or more solid adsorbents each comprises first and second desiccants in metal-organic frameworks (MOFs) with different organic linking chemistries.

6. The independent dehumidification element according to claim 1, wherein the at least two or more solid adsorbents respectively comprise:
a first desiccant in a metal-organic framework (MOF) with first multiple metallic center chemistries; and
a second desiccant in an MOF with second multiple metallic center chemistries differing from the first multiple metallic center chemistries.

7. A heat exchanger, comprising:
a plurality of tubes; and
a plurality of fins,
each fin of the plurality of fins being in thermal contact with at least one tube of the plurality of tubes,
each fin of the plurality of fins and each tube of the plurality of tubes having a surface comprising an adsorbent coating, and
the adsorbent coating comprising at least two or more solid adsorbents that differ from one another.

8. The heat exchanger according to claim 7, wherein the at least two or more solid adsorbents are each selected from a group comprising desiccants in metal-organic frameworks (MOFs), desiccants in MOFs with integrated graphite, silica-based desiccants, molecular sieves, zeolites and polymer-based desiccants.

9. The heat exchanger according to claim 7, wherein the at least two or more solid adsorbents each comprises a desiccant in a metal-organic framework (MOF) and a silica-based desiccant.

10. The heat exchanger according to claim 7, wherein the at least two or more solid adsorbents each comprises first and second desiccants in metal-organic frameworks (MOFs) with different metallic center chemistries.

11. The heat exchanger according to claim 7, wherein the at least two or more solid adsorbents each comprises first and second desiccants in metal-organic frameworks (MOFs) with different organic linking chemistries.

12. The heat exchanger according to claim 7, wherein the at least two or more solid adsorbents respectively comprise:
a first desiccant in a metal-organic framework (MOF) with first multiple metallic center chemistries; and
a second desiccant in an MOF with second multiple metallic center chemistries differing from the first multiple metallic center chemistries.

13. The heat exchanger according to claim 7, wherein:
the respective pluralities of tubes and fins are arranged in layers, and
the adsorbent coating comprising the at least two or more solid adsorbents of one of the layers differs from the adsorbent coating comprising the at least two or more solid adsorbents of another one of the layers.

14. The heat exchanger according to claim 7, wherein:
the respective pluralities of tubes and fins are arranged in sections, and
the adsorbent coating comprising the at least two or more solid adsorbents of one of the sections differs from the adsorbent coating comprising the at least two or more solid adsorbents of another one of the sections.

15. A dehumidification system, comprising:
first and second heat exchangers in one of a series arrangement and a parallel arrangement,
each of the first and second heat exchangers comprising:
a plurality of tubes; and
a plurality of fins,
each fin of the plurality of fins being in thermal contact with at least one tube of the plurality of tubes, and
each fin of the plurality of fins and each tube of the plurality of tubes having a surface comprising an adsorbent coating,
wherein each adsorbent coating of each of the first and second heat exchangers comprises first and second solid adsorbents, which differ from one another.

16. The heat exchanger according to claim 15, wherein:
the first solid adsorbent of each adsorbent coating of each of the first and second heat exchangers is selected from a group comprising desiccants in metal-organic frameworks (MOFs), desiccants in MOFs with integrated graphite, silica-based desiccants, molecular sieves, zeolites and polymer-based desiccants, and
the second solid adsorbent of each adsorbent coating of each of the first and second heat exchangers is selected from a group comprising desiccants in metal-organic frameworks (MOFs), desiccants in MOFs with integrated graphite, silica-based desiccants, molecular sieves, zeolites and polymer-based desiccants.

17. The dehumidification system according to claim 15, wherein the first solid adsorbent comprises a desiccant in a metal-organic framework (MOF) and the second solid adsorbent comprises a silica-based desiccant.

18. The dehumidification system according to claim 15, wherein the first and second solid adsorbents of each adsorbent coating of each of the first and second heat exchangers respectively comprise first and second desiccants in metal-organic frameworks (MOFs) with different metallic center chemistries.

19. The dehumidification system according to claim 15, wherein the first and second solid adsorbents of each adsorbent coating of each of the first and second heat exchangers respectively comprise first and second desiccants in metal-organic frameworks (MOFs) with different organic linking chemistries.

20. The dehumidification system according to claim 15, wherein:
the first solid adsorbent of each adsorbent coating of each of the first and second heat exchangers comprises a first desiccant in a metal-organic framework (MOF) with first multiple metallic center chemistries; and
the second solid adsorbent of each adsorbent coating of each of the first and second heat exchangers comprises a second desiccant in an MOF with second multiple metallic center chemistries differing from the first multiple metallic center chemistries.
